(19) United States
(12) Patent Application Publication
(10) Pub. No.: US 2025/0243869 A1
(43) Pub. Date: Jul. 31, 2025

(54) CONNECTION ADAPTER FOR THE DETACHABLE CONNECTION OF AN IMPELLER TO A SHAFT, ROTOR UNIT ASSEMBLY FORMED THEREBY AND METHOD FOR PRODUCING A TURBO COMPRESSOR WITH SUCH A ROTOR ASSEMBLY

(71) Applicant: emb-papst Mulfingen GmbH & Co. KG, Mulfingen (DE)

(72) Inventors: Christoph CARLE, Forchtenberg (DE); Philipp HANDSCHUH, Nuertingen (DE); Mihai B. DOBRICA, Heidelberg (DE); Michael WILKE, Schrozberg (DE)

(21) Appl. No.: 19/041,947

(22) Filed: Jan. 30, 2025

(30) Foreign Application Priority Data
Jan. 31, 2024 (DE) 102024102697.9

(51) Int. Cl. F04D 29/054; F04D 17/10; F04D 29/02; F04D 29/28

(52) U.S. Cl. CPC F04D 29/054; F04D 17/10; F04D 29/023; F04D 29/284

(57) ABSTRACT

A connection adapter for the detachable connection of an impeller with a shaft made of ceramic or tungsten carbide, to a rotor assembly for a turbo compressor. The connection adapter has an impeller section for fixing the impeller to the connection adapter and a shaft section for fixing the connection adapter to the shaft, and the impeller section has a first axial alignment means for axial alignment and a first radial alignment means for radial alignment of the impeller to the connection adapter. The shaft section has a second axial alignment means for axial alignment and a second radial alignment means for radial alignment of the shaft to the connection adapter, by way of which the impeller and the shaft are in a predetermined axial and radial alignment to one another on the connection adapter.

### RELATED APPLICATIONS

This application claims priority to German Patent Application No. 10 2024 102 697.9, filed Jan. 31, 2024, the entire contents of which is incorporated herein by reference in its entirety.

### FIELD

The disclosure relates to a connection adapter for the detachable connection of an impeller to a shaft, in particular comprising ceramic or tungsten carbide or consisting in particular of ceramic or tungsten carbide, a rotor assembly formed from the connection of the impeller to the shaft by the connecting element, and a method for producing a turbo compressor with such a rotor assembly.

### BACKGROUND

A large number of fluid kinetic machines or turbo compressors with rotor assemblies comprising an impeller and a shaft are known from the state of the art, whereby the impeller and shaft are often fixed directly to one another.

However, if one of the components, e.g. the impeller or the shaft, is made of certain materials, such as ceramic or a tungsten carbide alloy, or contains these materials in high concentrations, problems can arise when connecting the impeller and shaft, since the necessary fixtures can no longer be easily formed or provided on the respective component.

If, for example, the impeller is to be fixed to the shaft with a screw, a hole cannot be drilled and an internal thread cut in a shaft made of ceramic or with a high ceramic content without the very high probability of destroying the shaft.

### BRIEF SUMMARY

The present disclosure overcomes the aforementioned disadvantages and enables and/or simplifies the fixation of an impeller to a shaft, in particular when made of ceramic or a tungsten carbide alloy.

According to the disclosure, a preferably one-piece connection adapter is therefore proposed for the detachable connection of an impeller with a shaft, in particular comprising ceramic or tungsten carbide or a tungsten carbide alloy and in particular consisting entirely of ceramic or a tungsten carbide alloy, to a rotor assembly that can rotate about a rotation axis for a particularly oil-free turbo compressor, which is, for example, a high-speed turbo compressor. The term turbo compressor covers radial, axial and diagonal compressors, so that the turbo compressor in this case can also be an axial compressor, a radial compressor or a diagonal compressor. The connection adapter has an impeller section especially for the intended detachable fixation of the impeller to the connection adapter and a shaft section especially for the intended permanent fixation of the connection adapter to the shaft. In this case, the term “detachable as intended” means that the connection can be easily released and later restored without causing any damage using an appropriate hand tool, such as a wrench or Allen key, and the term “permanent as intended” means that the connection can only be released with great effort but preferably without causing any damage. The impeller section has a first axial alignment means for axial alignment and a first radial alignment means for radial alignment of the impeller on the connection adapter, and the shaft section has a second axial alignment means for axial alignment and a second radial alignment means for radial alignment of the shaft on the connection adapter, by means of which the impeller and the shaft can be fixed to the connection adapter in a predetermined axial and radial, i.e. in particular concentric, alignment with one another.

Because the impeller and shaft can be fixed to one another in a predetermined alignment, the balancing of a rotor assembly produced by the impeller, the shaft and the connection adapter is maintained even if the fixation or connection, in particular of the impeller, is temporarily released during installation of the rotor assembly or the turbo compressor and is later restored.

In the context of this description, axial direction, radial direction and circumferential direction refer to the axis of rotation, unless otherwise stated in the specific case.

An advantageous variant of the connection adapter provides that the impeller section has a thread for producing a screw connection with the impeller. The thread can be an internal thread, extending in particular with its longitudinal axis in the axial direction, so that the impeller can be screwed to the internal thread via a screw or an external thread formed by the impeller. Alternatively, the thread can be an external thread, extending in particular with its longitudinal axis in the axial direction, so that the impeller can be screwed to the external thread via a nut or an internal thread formed by the impeller.

When using a screw or a nut, it should be noted that the impeller is preferably pressed against the connection adapter, i.e. fixed to it with a force fit.

It can also be provided that the shaft section forms or has a joining section designed as a joining partner of a fit. The joining section can be designed as a pin, in particular with its longitudinal axis protruding in the axial direction, for joining with a receptacle provided on the shaft and corresponding thereto, so that the connection adapter can be connected to the shaft in particular permanently via the fit formed by the pin and the receptacle. Alternatively, the joining section can be designed as a sleeve, in particular with its longitudinal axis extending in the axial direction, or as a pot for joining with a projection provided on the shaft and corresponding thereto, so that the connection adapter can be connected to the shaft in particular permanently via the fit formed by the sleeve and the projection. The fit can in particular be a transition fit or an interference fit.

A first circumferential alignment means for aligning the impeller on the connection adapter in a predetermined position can also be provided on the impeller section. Additionally or alternatively, a second circumferential alignment means for aligning the connection adapter on the shaft in a predetermined position can be provided on the shaft section. Accordingly, the impeller and/or the shaft can be fixed to the connection adapter in a predetermined alignment in the circumferential direction relative to one another by the first and/or second circumferential alignment means.

In a simple case, the first and/or the second circumferential alignment means can be provided as a marking, by means of which the respective component with a respective corresponding marking can be brought into a predetermined alignment in the circumferential direction and can then be fixed in this.

Alternatively, the first and/or second circumferential alignment means can also be, for example, a coding key, for which a corresponding recess must be provided in the respective component, i.e. in the impeller or the shaft. The functional reversal is also possible, so that the respective recess can be provided on the connection adapter and the coding key on the respective component.

A further development of the connection adapter is also designed to extend at least with its impeller section in the axial direction into the impeller or to encompass the impeller radially on the outside, so that the connection adapter overlaps with the impeller at least in its impeller section in the axial direction.

Furthermore, the connection adapter can be designed to extend into the shaft at least with its shaft section in the axial direction or to encompass the shaft radially on the outside, so that the connection adapter overlaps with the shaft at least in its shaft section in the axial direction.

Preferably, the impeller section and the shaft section are designed such that an axial overlap of the impeller fixed to the connection adapter with the shaft fixed to the connection adapter is produced, i.e. the impeller and shaft overlap in the axial direction.

Furthermore, the connection adapter can have a balancing section, which is provided or arranged in particular between the impeller section and the shaft section, for balancing the connection adapter or a unit made up of the connection adapter and shaft or a unit made up of the connection adapter and impeller or the rotor unit. For this purpose, a mass designed for material removal, i.e. an excess material designed for material removal and/or interfaces for fixing balancing weights, are provided in the balancing section.

In order to ensure a thermal connection of the impeller to the shaft and vice versa, the impeller section can be connected to the shaft section in a thermally conductive manner and the connection adapter can be designed to connect the impeller to the shaft in a thermally conductive manner or for heat dissipation.

The material used for the connection adapter can be, for example, steel, titanium or corrosion-resistant nickel-based alloys, with the latter being particularly suitable for an alloy that was widely used under the brand name Inconel at the time of filing.

One aspect of the disclosure further relates to a rotor assembly with an impeller of a shaft and a connection adapter according to the disclosure connecting the impeller to the shaft. The impeller and the shaft are aligned axially and radially and preferably in the circumferential direction relative to one another in a predetermined position and are fixed to one another in this position via the connection adapter.

Furthermore, one aspect of the disclosure relates to a method for producing a turbo compressor or axial, radial or diagonal compressor with a rotor assembly that can be driven by an electric motor. According to the method, the impeller is fixed to the shaft in a predetermined orientation via the connection adapter and the rotor assembly formed thereby is balanced. The impeller of the balanced rotor assembly is then dismantled from the connection adapter, which can be done during the initial manufacture of the turbo compressor or, for example, as part of a later maintenance or repair. In particular against the background of maintenance or repair, the connection adapter with the shaft of the balanced rotor assembly fixed to it remains inserted in a housing of the turbo compressor or is inserted into such a housing, for example during initial manufacture. At a later point in time, the impeller is then fixed to the connection adapter inserted with the rotor assembly in the housing of the turbo compressor in the predetermined axial and/or radial orientation and/or orientation in the circumferential direction, so that the previously carried out balancing is retained despite the temporary dismantling of the rotor assembly.

The features disclosed above can be combined as desired, as long as this is technically possible and they do not contradict each other.

### BRIEF DESCRIPTION OF THE DRAWINGS

Other advantageous developments of the disclosure are characterized in the subclaims or are described in more detail below together with the description of the preferred embodiment of the disclosure with reference to the figures. They show:

FIG. 1 shows a rotor assembly comprising a first variant of a connection adapter;

FIG. 2 a rotor assembly comprising a second variant of a connection adapter.

### DETAILED DESCRIPTION

The figures are schematic examples. Identical reference symbols in the figures indicate identical functional and/or structural features.

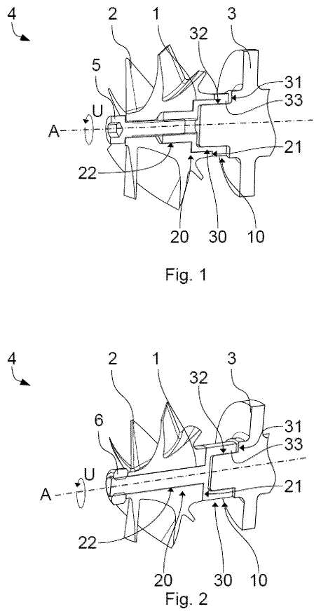

FIGS. 1 and 2 each show a rotor assembly 4 which can be rotated about a rotation axis A, but which provides differently designed connecting elements 1 with a corresponding impeller 2 and a shaft 3.

Regardless of the specific design, the connecting elements 1 each have an impeller section 20 and a shaft section 30.

The impeller 2 can be aligned axially and radially on the impeller section 20 via a first axial alignment means 21 designed as an axial stop and a first radial alignment means 22 designed as an (outer) fitting surface extending in the circumferential direction U.

Analogously, the shaft 3 can be axially and radially aligned on the shaft section 30 via a second axial alignment means 31 designed as an axial stop and a second radial alignment means 32 designed as an (inner) fitting surface of a sleeve 33 extending in the circumferential direction U.

The shaft 3, which is preferably made entirely or at least substantially of ceramic or tungsten carbide, is pressed into the sleeve 33 via an interference or transition fit and is thereby fixed to the connection adapter 1.

According to the variant shown in FIG. 1, an internal thread is provided in the impeller section 20, into which a screw 5 can be screwed for fixing the impeller 2.

Deviating from this, in FIG. 2, an external thread is formed by the connection adapter 1 adjacent to the first radial alignment means 22 designed as an (external) fitting surface, to which a nut 6 can be screwed for fixing the impeller 2.

In order to be able to balance the rotor assembly 4 or to pre-balance the rotor unit 4 before a subsequent final balancing, a balancing section 10 is provided in each case, at which material can be removed for balancing.

The disclosure is not limited in its implementation to the preferred design given above. Rather, a number of variants are conceivable which make use of the solution presented even in fundamentally different designs.

1. A connection adapter for the detachable connection of an impeller with a shaft to a rotor assembly for a turbo compressor that can rotate about a rotation axis, the connection adapter comprising:
an impeller section for fixing the impeller to the connection adapter, and
a shaft section for fixing the connection adapter to the shaft,
wherein the impeller section has a first axial alignment means for axial alignment and a first radial alignment means for radial alignment of the impeller on the connection adapter and the shaft section has a second axial alignment means for axial alignment and a second radial alignment means for radial alignment of the shaft on the connection adapter, by means of which the impeller and the shaft can be fixed to the connection adapter in a predetermined axial and radial alignment with respect to one another.

2. The connection adapter according to claim 1,
wherein the impeller portion has a thread for establishing a screw connection with the impeller,
wherein the thread is an internal thread extending with its longitudinal axis in the axial direction, so that the impeller can be screwed to the internal thread via a screw or an external thread formed by the impeller, or
wherein the thread is an external thread extending with its longitudinal axis in the axial direction, so that the impeller can be screwed to the external thread by a nut or an internal thread formed by the impeller.

3. The connection adapter according to claim 1,
wherein the shaft portion forms or has a joining portion configured as a joining partner of a fit,
wherein the joining section is configured as a pin with its longitudinal axis protruding in the axial direction, for joining with a receptacle provided on the shaft and corresponding thereto, so that the connection adapter can be connected to the shaft via the fit formed by the pin and the receptacle, or
wherein the joining section is configured as a sleeve extending with its longitudinal axis in the axial direction for joining with a projection provided on the shaft and corresponding thereto, so that the connection adapter can be connected to the shaft via the fit formed by the sleeve and the projection,
and wherein the fit is a transition fit or an interference fit.

4. The connection adapter according to claim 1,
wherein a first circumferential alignment means for aligning the impeller on the connection adapter in a predetermined position is provided on the impeller section and/or
wherein a second circumferential alignment means is provided on the shaft portion for aligning the connection adapter on the shaft in a predetermined position, by way of which the impeller and the shaft can be fixed to the connection adapter in a predetermined orientation in the circumferential direction relative to one another.

5. The connection adapter according to claim 1,
wherein the connection adapter is configured to extend at least with its impeller section in the axial direction into the impeller or to encompass the impeller radially on the outside, so that the connection adapter overlaps with the impeller in the axial direction at least in its impeller section.

6. The connection adapter according to claim 1,
wherein the connection adapter is configured to extend at least with its shaft section in the axial direction into the shaft or to encompass the shaft radially on the outside, so that the connection adapter overlaps with the shaft in the axial direction at least in its shaft section.

7. The connection adapter according to claim 1,
wherein the impeller section and the shaft section are designed to produce an axial overlap of the impeller fixable to the connection adapter with the shaft fixable to the connection adapter.

8. The connection adapter according to claim 1,
further comprising a balancing section provided between the impeller section and the shaft section for balancing the connection adapter or a unit comprising the connection adapter and the shaft or a unit comprising the connection adapter and the impeller or the rotor assembly,
wherein a mass configured for material removal and/or interfaces for fixing balancing weights are provided in the balancing section.

9. The connection adapter according to claim 1,
wherein the impeller section is connected to the shaft section in a thermally conductive manner and the connection adapter is designed to connect the impeller to the shaft in a thermally conductive manner.

10. A rotor assembly with an impeller of a shaft and a connection adapter connecting the impeller to the shaft configured according to claim 1,
wherein the impeller and the shaft are axially and radially aligned with each other and fixed to each other via the connecting adapter.

11. A method for producing a turbo compressor with a rotor assembly drivable by an electric motor and the rotor assembly configured according to claim 1,
wherein the impeller is fixed to the shaft in a predetermined orientation via the connection adapter and the rotor assembly formed thereby is balanced,
wherein the impeller of the balanced rotor assembly is dismantled from the connection adapter,
wherein the connecting adapter with the shaft of the balanced rotor assembly fixed thereto remains or is inserted in a housing of the turbo compressor,
and wherein the impeller is fixed in the predetermined orientation to the connection adapter inserted with the rotor assembly in the housing of the turbo compressor.

12. The connection adapter according to claim 1, wherein the shaft is made of ceramic or tungsten carbide.
